(19) United States
(12) Patent Application Publication
(10) Pub. No.: US 2025/0139251 A1
(43) Pub. Date: May 1, 2025

(54) SECURE CODE ANALYSIS COPILOT

(71) Applicant: CrowdStrike, Inc., Sunnyvale, CA (US)

(72) Inventors: Paul Sumedrea, Bucharest (RO); Cristian Viorel Popa, Bucharest (RO); Vasile-Daniel Sava, Vaslui (RO)

(21) Appl. No.: 18/495,626

(22) Filed: Oct. 26, 2023

(51) Int. Cl. G06F 21/57; G06F 8/72; G06F 21/56

(52) U.S. Cl. CPC G06F 21/577; G06F 8/72; G06F 21/563

(57) ABSTRACT

An approach is provided that identifies a vulnerability corresponding to an initial source code. Then, the approach generates a prompt comprising the initial source code and the vulnerability. The approach inputs the prompt into an artificial intelligence model (AIM) that is trained to determine whether the initial source code comprises the vulnerability. In turn, the approach removes, using the AIM, the vulnerability from the initial source code to produce a refactored source code in response to determining that the initial source code comprises the vulnerability.

### TECHNICAL FIELD

Aspects of the present disclosure relate to secure code generation, and more particularly, to training an artificial intelligence model and using the trained artificial intelligence model as a secure code analysis copilot.

### BACKGROUND

Writing secure code is important to protect against cybersecurity threats. Safeguarding sensitive data, maintaining system integrity, and thwarting malicious attacks are all contingent on the quality of the code underpinning software applications. Software developers are often burdened with the task of writing boilerplate code that adheres to established security protocols and standards. These repetitive tasks can divert their focus from more critical security concerns, such as identifying and mitigating novel threats.

Recognizing this, many security experts are increasingly turning to code assisting tools, also referred to as copilots or code assistants. Code assisting tools streamline the development process by generating source code snippets, thus allowing developers to delegate routine coding tasks and allocate more time to strategic threat analysis and proactive security measures.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system that produces a security code analysis copilot artificial intelligence model (AIM) for refactoring code, in accordance with some embodiments of the present disclosure.

FIG. 2 is a block diagram that illustrates an example system that uses a security analysis copilot AIM to remove vulnerabilities from source code, in accordance with some embodiments of the present disclosure.

FIG. 3A is a is a block diagram that illustrates an example system of adding zero-day vulnerability information to a prompt to assist the security code analysis copilot AIM in determining whether initial source code includes the zero-day vulnerability, in accordance with some embodiments of the present disclosure.

FIG. 3B is a is a block diagram that illustrates an example system of fine-tuning the security code analysis copilot AIM with new vulnerability information, in accordance with some embodiments of the present disclosure.

FIG. 4 is a flow diagram of a method for using a security analysis copilot AIM to remove vulnerabilities from source code, in accordance with some embodiments of the present disclosure.

FIG. 5 is a is a block diagram that illustrates an example system for using a security analysis copilot AIM to remove vulnerabilities from source code, in accordance with some embodiments of the present disclosure.

FIG. 6 illustrates a diagrammatic representation of a machine in the example form of a computer system within which a set of instructions, for causing the machine to perform any one or more of the methodologies discussed herein for processing a query.

### DETAILED DESCRIPTION

As discussed above, a code assistant is a software tool designed to aid developers in various aspects of the coding process. While coding assistants can enhance development efficiency, they also introduce several challenges, particularly in the realm of security. Coding assistants are typically trained using data from the Internet and, as such, may incorporate flawed practices found on the Internet into their own code generation. For example, coding assistants may propose code snippets that inadvertently introduce security vulnerabilities, such as SQL injection or cross-site scripting. Without careful review, developers may incorporate these suggestions into their codebase, leaving the resultant application susceptible to attacks.

Coding assistants may also not fully understand the security context of a project. A coding assistant may suggest code that meets functional requirements, but fails to address security considerations, potentially exposing an application to risks. In addition, coding assistants often suggest third-party libraries or dependencies to accelerate development. However, these libraries may contain vulnerabilities or be outdated, posing security threats if integrated without proper vetting.

Some coding assistants operate by analyzing existing code or user patterns. This approach could raise privacy concerns if sensitive information inadvertently becomes part of the analysis, potentially leading to data leaks or breaches. In addition, relying too heavily on coding assistants may discourage developers from understanding the underlying security principles. This can lead to a lack of awareness about potential vulnerabilities and how to address about potential vulnerabilities. Furthermore, developers may assume that code generated by coding assistants is secure simply because the code is generated by a tool. This can result in complacency and insufficient security testing, leaving vulnerabilities undetected.

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. As discussed herein, artificial intelligence models, or AI models, include machine learning models, large language models, and other types of models that are based on neural networks, genetic algorithms, expert systems, Bayesian networks, reinforcement learning, decision trees, or combination thereof.

Code refactoring is the process of restructuring existing code to improve its readability, maintainability, and efficiency without changing its external behavior. Code refactoring aims to simplify complex code, remove redundancy, and enhance code quality, making the refactored code easier to understand and maintain. The present disclosure addresses the above-noted and other deficiencies by providing an approach of refactoring source code to remove vulnerabilities. The approach identifies a vulnerability corresponding to an initial source code and generates a prompt comprising the initial source code and the vulnerability. The approach inputs the prompt into an artificial intelligence model (AIM) that is trained to determine whether the initial source code comprises the vulnerability. In turn, the approach removes, by a processing device using the AIM, the vulnerability from the initial source code to produce a refactored source code in response to determining that the initial source code comprises the vulnerability.

In some embodiments, the approach detects a zero-day vulnerability by analyzing the initial source code by using a vulnerability scanner. The approach determines one or more zero-day refactoring operations corresponding to the zero-day vulnerability, and generates a new prompt comprising the initial source code, the zero-day vulnerability, and the one or more zero-day refactoring operations. In response to inputting the new prompt into the AIM, the approach determines, by the AIM, that the initial source code comprises the zero-day vulnerability. The approach then uses the AIM to remove the zero-day vulnerability from the initial source code to produce a new refactored source code. In some embodiments, the AIM may not have seen this particular zero-day vulnerability during its training stage, but is able to detect the zero-day vulnerability based on its similarity with other vulnerabilities in the training corpus or exhibit zero-shot performance on the zero-day vulnerability. Zero-shot performance refers to a model's ability to generate accurate and coherent responses or predictions for tasks or inputs for which the model has not been trained.

In some embodiments, the AIM is a security code analysis copilot AIM. Prior to identifying the vulnerability, the approach generates a training prompt that comprises training source code, one or more vulnerabilities contexts corresponding to the training source code, and one or more code refactoring technique descriptions. The approach inputs the training prompt and a ground truth into a pretrained AIM, wherein the pretrained AIM performs fine tune training based on the training prompt and the ground truth to produce the security code analysis copilot AIM. In some embodiments, the approach detects one or more new vulnerabilities. In response to determining that the one or more new vulnerabilities comprise one or more distinguishing contexts relative to the one or more vulnerabilities contexts, the approach retrains the security code analysis copilot AIM. During the retraining, the approach generates a new training prompt that comprises new training source code, the one or more new vulnerabilities, and the one or more distinguishing contexts. The approach then inputs the new training prompt into the security code analysis copilot AIM, wherein the security code analysis copilot AIM performs new fine tune training based on the new prompt to produce a retrained security code analysis copilot AIM.

In some embodiments, the AIM produces a plurality of refactored candidate samples. The approach tests at least a portion of code included in each of the plurality of refactored candidate samples to produce one or more test results. For example, the approach may test, for each of the plurality of refactored candidate samples, whether the portion of the code is compilable. The approach then constructs the refactored source code based on the one or more test results.

In some embodiments, the vulnerability is identified by a vulnerability scanner. The vulnerability scanner determines one or more properties of the initial source code, and identifies, based on the one or more properties, the vulnerability from a plurality of vulnerabilities included in a global vulnerability database.

In some embodiments, the approach evaluates the initial source code by the AIM prior to generating the prompt. The approach identifies, by the AIM in response to evaluating the initial source code, a plurality of potential vulnerabilities that correspond to the initial source code. The approach generates a new prompt comprising the initial source code and the plurality of potential vulnerabilities. In response to inputting the new prompt into the AIM, the approach determines, using the AIM, that the initial source code comprises a first vulnerability from the plurality of potential vulnerabilities. The approach removes, using the AIM, the first vulnerability from the initial source code to produce a new refactored source code.

As discussed herein, the present disclosure provides an approach that improves the operation of a computer system by reducing cybersecurity threats in software code that executes on the computer system. In addition, the present disclosure provides an improvement to the technological field of software development by providing an automated approach for software developers to refactor their source code and remove vulnerabilities.

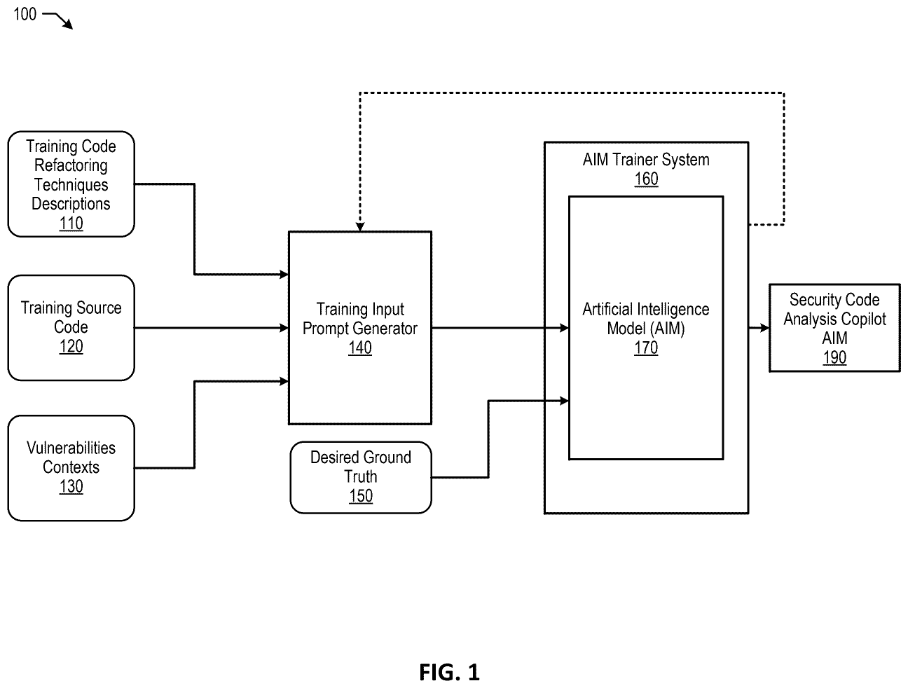

FIG. 1 is a block diagram that illustrates an example system that produces a security code analysis copilot artificial intelligence model (AIM) for refactoring code, in accordance with some embodiments of the present disclosure. System 100 uses AIM trainer system 160 to iteratively train AIM 170 to perform a range of predefined tasks for refactoring source code from a security perspective. In some embodiments, AIM 170 is a pre-trained model (e.g., a foundational model) and AIM trainer system 160 fine-tunes AIM 170 to produce security code analysis copilot AIM 190 as discussed herein.

Training input prompt generator 140 uses training code refactoring technique descriptions 110, training source code 120, and vulnerabilities context 130 to generate prompts and provide the prompts to AIM 170. Training code refactoring technique descriptions 110 involve articulating the various strategies and practices employed to improve the structure, efficiency, and maintainability of source code. These descriptions encompass a wide range of approaches, such as method extraction, variable renaming, class reorganization, and optimization of algorithms. Training source code 120 includes actual code snippets, scripts, and programs as input data to train AIM 170 the intricacies of programming languages, syntax, and common coding patterns. By exposing AIM 170 to a diverse range of source code examples from various programming languages and domains, AIM 170 learns to understand code logic, anticipate programmer intentions, and generate contextually relevant code snippets in response to prompts. Vulnerabilities context 130 includes information about the environmental, technical, and operational factors that contribute to the existence, exploitation, and potential impact of security vulnerabilities within a system, application, or software. Vulnerabilities context 130 encompasses the conditions, configurations, dependencies, and interactions that can expose weaknesses or flaws in the software's design, implementation, or usage.

In addition to the prompt generated by training input prompt generator 140, AIM trainer system 160 also inputs desired ground truth 150 into AIM 170. Desired ground truth 150 includes authoritative and accurate reference data that serves as the benchmark or standard against which other data or predictions are evaluated or validated by AIM 170. Using desired ground truth 150 to train AIM 170 involves providing AIM 170 with curated and labeled data that represents correct and verified examples of desired outputs.

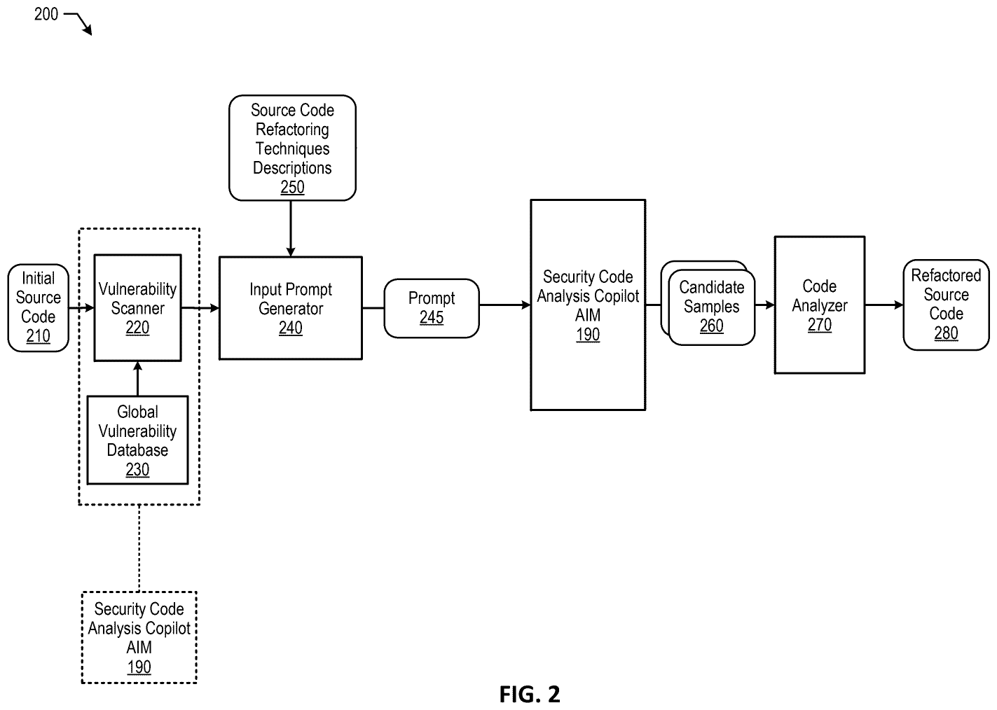

During training, AIM 170 learns from desired ground truth 150, adapting its parameters to generate responses or predictions that align with the provided correct answers. This training process enables AIM 170 to iteratively improve its performance, enhance its understanding of language patterns, generate more accurate and contextually relevant outputs, and transform into security code analysis copilot AIM 190. As such, security code analysis copilot AIM 190 is trained to identify and remove vulnerabilities from initial source code and produce refactored source code (see FIGS. 2, 4, 5, and corresponding text for further details).

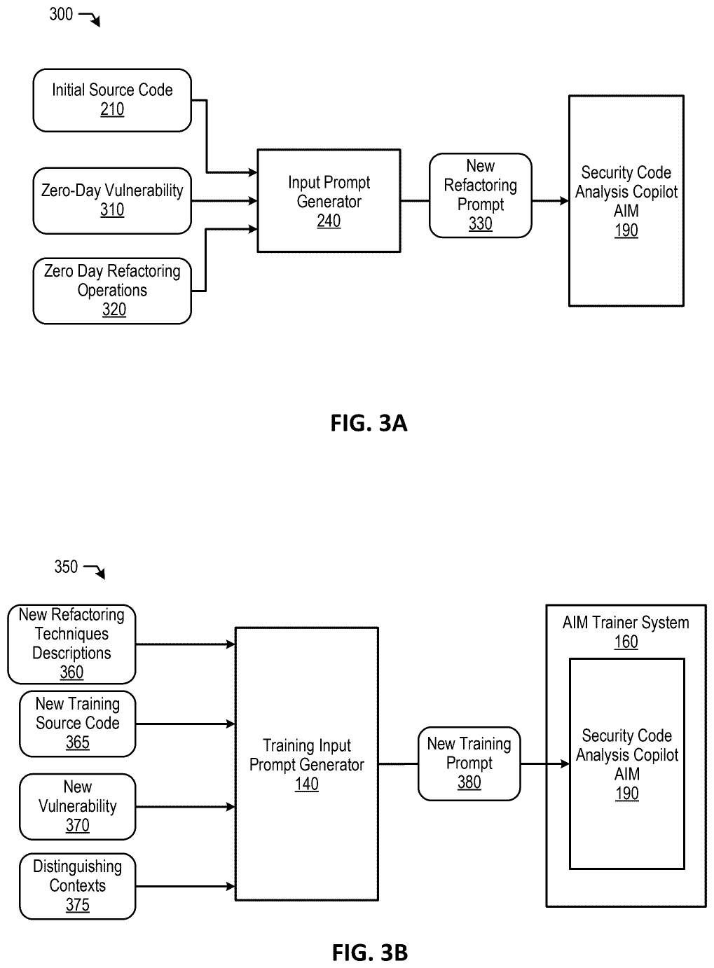

In some embodiments, system 100 performs instruction tuning to mitigate a particular class of vulnerabilities. This enables security code analysis copilot AIM 190 open for future prompt engineering/prompt tuning without requiring a full retraining each time a new critical patch to a new vulnerability is introduced to achieve an improved zero-shot performance. As discussed above, zero-shot performance refers to a model's ability to generate accurate and coherent responses or predictions for tasks or inputs for which the model has not been trained (see FIG. 3B, and corresponding text for further details).

In some embodiments, system 100 may enable a user that identifies a zero-day vulnerability to patch the vulnerability by designing a sufficient prompt that defines refactoring steps which need to be followed. A zero-day vulnerability is a security flaw in software or hardware that is exploited by malicious actors before a vendor or developers are aware of the security flaw, leaving insufficient time for a patch or fix to be developed (see FIG. 3A and corresponding text for further details).

In some embodiments, security code analysis copilot AIM 190 may be further fine-tuned to generate desired outcomes through signals from tests that are pre-written by a developer to test the functionality of the software.

FIG. 2 is a block diagram that illustrates an example system that uses a security analysis copilot AIM to remove vulnerabilities from source code, in accordance with some embodiments of the present disclosure.

Vulnerability scanner 220 receives initial source code 210 and accesses global vulnerability database 230 to identify possible vulnerabilities corresponding to initial source code 210. Global vulnerability database 230, in some embodiments, is a comprehensive repository that catalogs and tracks known security weaknesses, vulnerabilities, and exposures across various software, hardware, and systems worldwide.

In some embodiments, vulnerability scanner 220 recursively evaluates external dependencies (e.g. library imports) of initial source code 210 to determine whether a match to the dependencies exists, or similar entries exist, in global vulnerability database 230. For example, a vulnerability may have been previously discovered in a Log4J library. Log4j (Apache Log4j) is an open-source logging framework for Java applications. If an entry about the vulnerability was previously added to global vulnerability database 230 that links the vulnerability to the library, vulnerability scanner 220 recognizes this is a threat for codebases that rely on Log4J, either directly or indirectly. In some embodiments, if the vulnerability is not linked to the library, the vulnerability may be under a “logging” category that vulnerability scanner 220 checks by string similarity, such as between raw names (“log 4j” and “logging”) or a description of Log4J.

In some embodiments, vulnerability scanner 220 may evaluate external URLs/APIs that initial source code 210 calls. Vulnerability scanner 220 may scan global vulnerability database 230 for an exact match or similar entries. For example, a social media application may have previously suffered a data breach, and global vulnerability database 230 may include an entry that includes a corresponding URL (e.g., https://api.socialapp.com/) or mark the data breach under a “social media” category. For this vulnerability, while the URL is the main issue, there may also be a corresponding library (e.g., Python requests package), that vulnerability scanner 220 recognizes as a possible vulnerability. In some embodiments, vulnerability scanner 220 may evaluate methods within initial source code 210 and match functions used to the vulnerability database.

In some embodiments, system 200 may use security code analysis copilot AIM 190 instead of vulnerability scanner 220 to identify vulnerabilities in a chain-of-thought or any other type of step by step reasoning prompting technique, such as when global vulnerability database 230 is inaccessible. For example, system 200 may question security code analysis copilot AIM 190 for a short description of what the code does/is a part of. Security code analysis copilot AIM 190 may then generate what security issues could come out from this type of code. System 200 then questions security code analysis copilot AIM 190 if these issues apply in initial source code 210 (and whether there are other vulnerabilities). For the ones found in initial source code 210, system 200 asks security code analysis copilot AIM 190 to elaborate a plan to remove the vulnerabilities.

Vulnerability scanner 220 (or security code analysis copilot AIM 190) feeds information pertaining to the possible vulnerabilities into input prompt generator 240. Source code refactoring technique descriptions 250 also feed into input prompt generator 240. Source code refactoring techniques descriptions 250 provide detailed explanations and guidelines for systematically restructuring and improving the quality of software code, enhancing its readability, maintainability, and efficiency. For example, an Extract Method refactoring technique involves taking a portion of code within a larger method and moving it into a separate method with a descriptive name that conveys its purpose. This improves code readability by breaking down complex logic into smaller, more understandable chunks and promotes code reuse. In turn, input prompt generator generates prompt 245 based on its inputs and feeds prompt 245 to security code analysis copilot AIM 190.

Security code analysis copilot AIM 190 produces candidate samples 260, which may be various options to refactor initial source code 210. Security code analysis copilot AIM 190 produces multiple candidate samples 260 to increases the probability that the refactored source code is executable. For example, security code analysis copilot AIM 190 may use a different random seed, or tweak a generation parameter, to produce slightly different answers (e.g., candidate samples 260). Then, code analyzer 270, in some embodiments, takes snippets of each of candidate samples 260, compiles the code snippets, and performs code analysis. In turn, code analyzer 270 produces refactored source code 280 based on the code analysis, which includes the same functionality as initial source code 210 without vulnerabilities.

In some embodiments, system 200 provides a zero-shot performance ability, or a few shot performance capability on unseen tasks. This performance is such that security code analysis copilot AIM 190 has not been trained on these new vulnerabilities but system 200 provides security code analysis copilot AIM 190 enough context around the vulnerability and how to mitigate/remove it from initial source code 210.

In some embodiments, to enforce a security first mindset, system 200 may include a downstream AIM responsible for generating test cases for a particular piece of software and discover additional vulnerabilities for iteratively refactoring the refactored source code.

FIG. 3A is a is a block diagram that illustrates an example system of adding zero-day vulnerability information to a prompt to assist the security code analysis copilot AIM in determining whether initial source code includes the zero-day vulnerability, in accordance with some embodiments of the present disclosure.

System 300 shows input prompt generator 240 generating new prompt 330 using initial source code 210, zero-day vulnerability 310, and zero-day refactoring operations 320. In some embodiments, a user identifies zero-day vulnerability 310 and formulates zero-day refactoring operations 320. In some embodiments, a real-time cybersecurity threat detection system identifies zero-day vulnerability 310 and formulates zero-day refactoring operations 320. Zero-day refactoring operations 320 encompass a set of structured actions and modifications applied to source code with the intent of improving its structure, readability, and maintainability while preserving its original functionality.

New prompt 330 enables security code analysis copilot AIM 190 to evaluate initial source code 210 and determine whether zero-day vulnerability 310 is included in initial source code 210 by using zero-day refactoring operations 320 as indicators. If security code analysis copilot AIM 190 detects zero-day vulnerability 310 in initial source code 210, security code analysis copilot AIM 190 removes zero-day vulnerability 310 to produce refactored source code as discussed herein.

FIG. 3B is a is a block diagram that illustrates an example system of fine-tuning the security code analysis copilot AIM with new vulnerability information, in accordance with some embodiments of the present disclosure. System 350 provides an approach for future prompt engineering/prompt tuning of security code analysis copilot AIM 190 without requiring a full retraining each time a new critical patch is introduced.

Training input prompt generator 140 receives new refactoring techniques descriptions 360, new training source code 365, new vulnerability 370, and distinguishing context 375 to generate new training prompt 380. New refactoring techniques descriptions 360 provide detailed explanations and guidelines for systematically restructuring and improving the quality of software code based new vulnerability. New training source code 365 includes samples that include new vulnerability 370. Distinguishing context 375 includes information that distinguishes new vulnerability 370 over previous vulnerabilities. AIM trainer system 160 fine tunes security code analysis copilot AIM 190 using new training prompt 380, which is now trained to detect and refactor initial source code that includes new vulnerability 370.

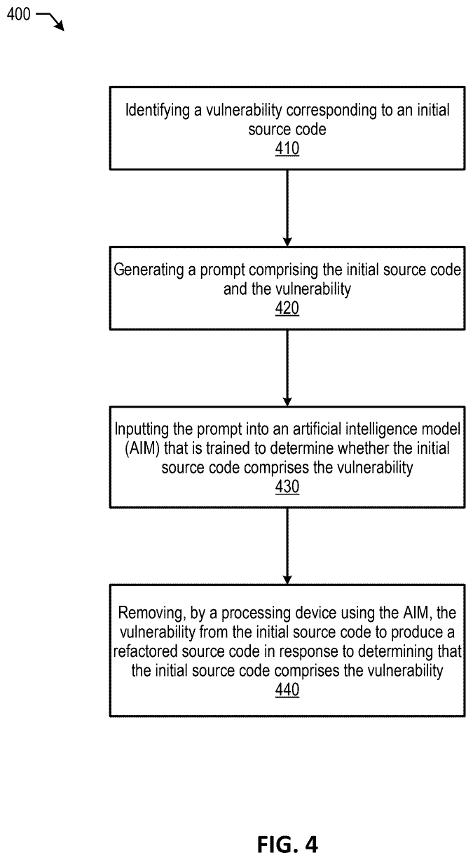

FIG. 4 is a flow diagram of a method for using a security analysis copilot AIM to remove vulnerabilities from source code, in accordance with some embodiments of the present disclosure.

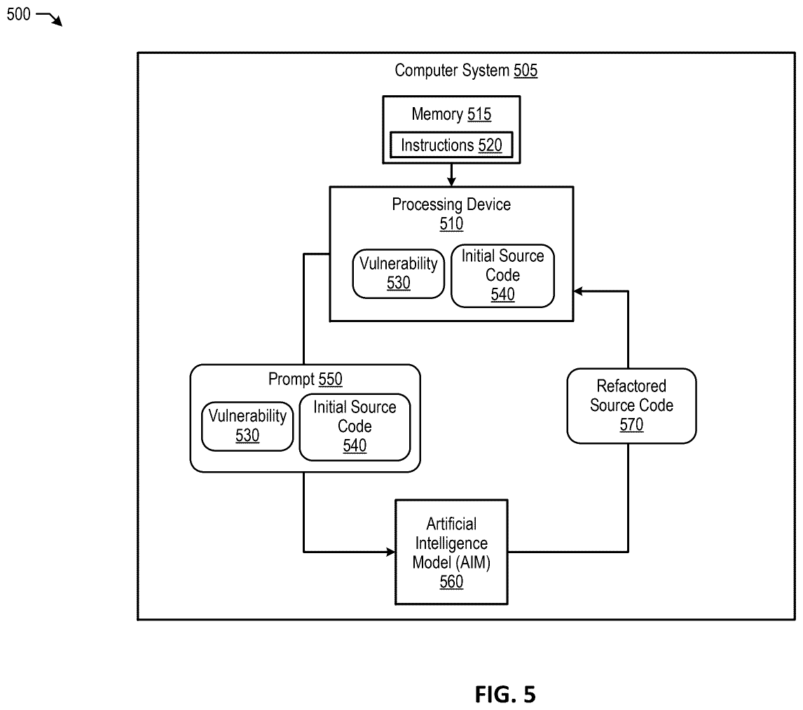

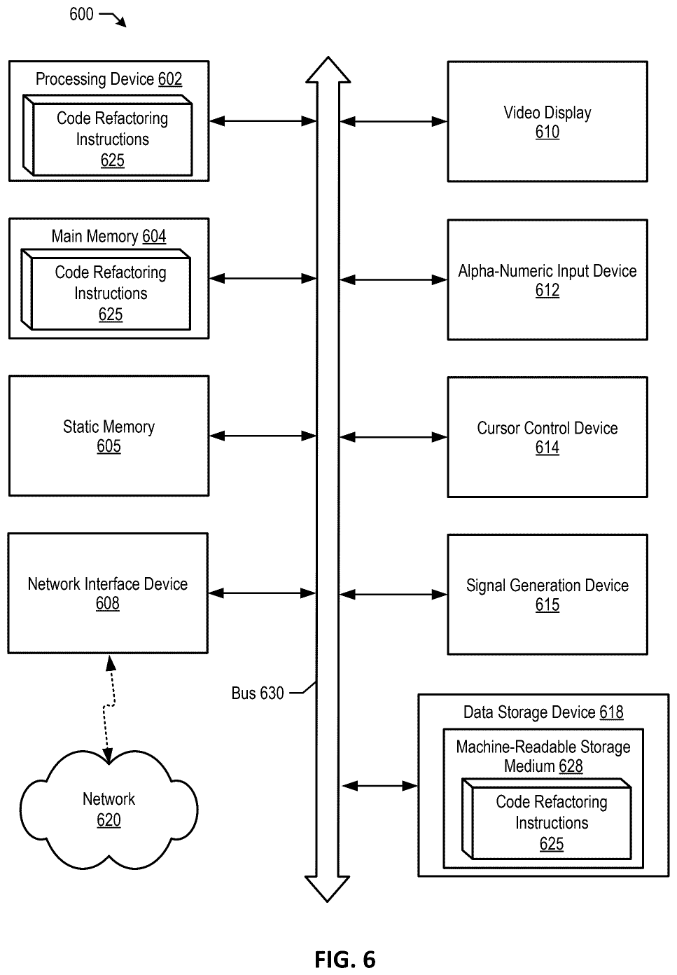

Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by input prompt generator 240, security code analysis copilot AIM 190, processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, where processing logic identifies a vulnerability corresponding to an initial source code. In some embodiments, the vulnerability is identified by a vulnerability scanner. The vulnerability scanner determines one or more properties of the initial source code, and identifies, based on the one or more properties, the vulnerability from a plurality of vulnerabilities included in a global vulnerability database.

In some embodiments, processing logic uses the AIM to evaluate the initial source code. Processing logic identifies, using the AIM in response to evaluating the initial source code, a plurality of potential vulnerabilities that correspond to the initial source code. Processing logic generates a new prompt comprising the initial source code and the plurality of potential vulnerabilities. In response to inputting the new prompt into the AIM, processing logic determines, using the AIM, that the initial source code comprises a first vulnerability from the plurality of potential vulnerabilities. Processing logic removes, using the AIM, the first vulnerability from the initial source code to produce a new refactored source code.

At block 420, processing logic generates a prompt comprising the initial source code and the vulnerability and, at block 430, processing logic inputs the prompt into an artificial intelligence model (AIM), which is trained to determine whether the initial source code comprises the vulnerability.

At block 440, processing logic uses the AIM to remove the vulnerability from the initial source code to produce a refactored source code in response to determining that the initial source code comprises the vulnerability. In some embodiments, the AIM produces a plurality of refactored candidate samples. Processing logic tests at least a portion of code included in each of the plurality of refactored candidate samples to produce one or more test results. Processing logic then constructs the refactored source code based on the one or more test results.

In some embodiments, processing logic detects a zero-day vulnerability corresponding to the initial source code, wherein the AIM has not been trained to determine whether the initial source code comprises the zero-day vulnerability but is able to detect the zero-day vulnerability due to its similarities with other vulnerabilities. Processing logic determines one or more zero-day refactoring operations corresponding to the zero-day vulnerability, and generates a new prompt comprising the initial source code, the zero-day vulnerability, and the one or more zero-day refactoring operations. In response to inputting the new prompt into the AIM, processing logic determines, by the AIM, that the initial source code comprises the zero-day vulnerability. Processing logic then uses the AIM to remove the zero-day vulnerability from the initial source code to produce a new refactored source code.

FIG. 5 is a is a block diagram that illustrates an example system for using a security analysis copilot AIM to remove vulnerabilities from source code, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to identify a vulnerability 530 corresponding to an initial source code 540. Processing device generates a prompt 550 comprising the initial source code 540 and the vulnerability 530 and inputs prompt 550 into AIM 560, which is trained to determine whether the initial source code comprises the vulnerability. Processing device 510 uses AIM 560 to remove vulnerability 530 from the initial source code 540 to produce a refactored source code 570 in response to AIM 560 determining that that the initial source code includes the vulnerability.

FIG. 6 illustrates a diagrammatic representation of a machine in the example form of a computer system 600 within which a set of instructions, for causing the machine to perform any one or more of the methodologies discussed herein for intelligently scheduling containers.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute code refactoring instructions 625, for performing the operations and steps discussed herein.

The data storage device 618 may include a machine-readable storage medium 628, on which is stored one or more sets of code refactoring instructions 625 (e.g., software) embodying any one or more of the methodologies of functions described herein. The code refactoring instructions 625 may also reside, completely or at least partially, within the main memory 604 or within the processing device 602 during execution thereof by the computer system 600; the main memory 604 and the processing device 602 also constituting machine-readable storage media. The code refactoring instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “identifying,” “generating,” “inputting,” “removing,” “detecting,” “determining,” “evaluating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112 (f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
identifying a vulnerability corresponding to an initial source code;
generating a prompt comprising the initial source code and the vulnerability;
inputting the prompt into an artificial intelligence model (AIM) that is trained to determine whether the initial source code comprises the vulnerability; and
removing, by a processing device using the AIM, the vulnerability from the initial source code to produce a refactored source code in response to determining that the initial source code comprises the vulnerability.

2. The method of claim 1, further comprising:
detecting a zero-day vulnerability corresponding to the initial source code, wherein the AIM has not been trained on the zero-day vulnerability;
determining one or more zero-day refactoring operations corresponding to the zero-day vulnerability;
generating a new prompt comprising the initial source code, the zero-day vulnerability, and the one or more zero-day refactoring operations;
in response to inputting the new prompt into the AIM, determining, by the AIM, that the initial source code comprises the zero-day vulnerability; and
removing, by the AIM, the zero-day vulnerability from the initial source code to produce a new refactored source code.

3. The method of claim 1, wherein the AIM is a security code analysis copilot AIM, and wherein, prior to identifying the vulnerability, the method further comprises:
generating a training prompt that comprises training source code, one or more vulnerabilities contexts corresponding to the training source code, and one or more code refactoring techniques descriptions;
inputting the training prompt and a ground truth into a pretrained AIM, wherein the pretrained AIM performs fine tune training based on the training prompt and the ground truth to produce the security code analysis copilot AIM.

4. The method of claim 3, further comprising:
detecting one or more new vulnerabilities;
in response to determining that the one or more new vulnerabilities comprise one or more distinguishing contexts relative to the one or more vulnerabilities contexts, retraining the security code analysis copilot AIM, wherein the retraining comprises:
generating a new training prompt that comprises new training source code, the one or more new vulnerabilities, and the one or more distinguishing contexts; and
inputting the new training prompt into the security code analysis copilot AIM, wherein the security code analysis copilot AIM performs new fine tune training based on the new prompt to produce a retrained security code analysis copilot AIM.

5. The method of claim 1, wherein the AIM produces a plurality of refactored candidate samples, the method further comprising:
testing at least a portion of code included in each of the plurality of refactored candidate samples to produce one or more test results; and
constructing the refactored source code based on the one or more test results.

6. The method of claim 1, wherein the vulnerability is identified by a vulnerability scanner the method further comprising:
determining, buy the vulnerability scanner, one or more properties of the initial source code; and
identifying, based on the one or more properties, the vulnerability from a plurality of vulnerabilities included in a global vulnerability database.

7. The method of claim 1, further comprising:
evaluating the initial source code by the AIM prior to generating the prompt;
identifying, by the AIM in response to evaluating the initial source code, a plurality of potential vulnerabilities that correspond to the initial source code;
generating a new prompt comprising the initial source code and the plurality of potential vulnerabilities;
in response to inputting the new prompt into the AIM, determining, by the AIM, that the initial source code comprises a first vulnerability from the plurality of potential vulnerabilities; and
removing, by the AIM, the first vulnerability from the initial source code to produce a new refactored source code.

8. A system comprising:
a processing device; and
a memory to store instructions that, when executed by the processing device, cause the processing device to:
identify a vulnerability corresponding to an initial source code;
generate a prompt comprising the initial source code and the vulnerability;
input the prompt into an artificial intelligence model (AIM) that is trained to determine whether the initial source code comprises the vulnerability; and
remove, using the AIM, the vulnerability from the initial source code to produce a refactored source code in response to a determination that the initial source code comprises the vulnerability.

9. The system of claim 8, wherein, responsive to executing the instructions, further causes the system to:
detect a zero-day vulnerability corresponding to the initial source code, wherein the AIM has not been trained on the zero-day vulnerability;
determine one or more zero-day refactoring operations corresponding to the zero-day vulnerability;
generate a new prompt comprising the initial source code, the zero-day vulnerability, and the one or more zero-day refactoring operations;
in response to inputting the new prompt into the AIM, determine, by the AIM, that the initial source code comprises the zero-day vulnerability; and
removing, by the AIM, the zero-day vulnerability from the initial source code to produce a new refactored source code.

10. The system of claim 8, wherein the AIM is a security code analysis copilot AIM, and wherein, responsive to executing the instructions, further causes the system to:
generating a training prompt that comprises training source code, one or more vulnerabilities contexts corresponding to the training source code, and one or more code refactoring techniques descriptions;
inputting the training prompt and a ground truth into a pretrained AIM, wherein the pretrained AIM performs fine tune training based on the training prompt and the ground truth to produce the security code analysis copilot AIM.

11. The system of claim 10, wherein, responsive to executing the instructions, further causes the system to:
detecting one or more new vulnerabilities;
in response to determining that the one or more new vulnerabilities comprise one or more distinguishing contexts relative to the one or more vulnerabilities contexts, retraining the security code analysis copilot AIM, wherein the retraining comprises:
generating a new training prompt that comprises new training source code, the one or more new vulnerabilities, and the one or more distinguishing contexts; and
inputting the new training prompt into the security code analysis copilot AIM, wherein the security code analysis copilot AIM performs new fine tune training based on the new prompt to produce a retrained security code analysis copilot AIM.

12. The system of claim 8, wherein the AIM produces a plurality of refactored candidate samples, and wherein, responsive to executing the instructions, further causes the system to:
testing at least a portion of code included in each of the plurality of refactored candidate samples to produce one or more test results; and
constructing the refactored source code based on the one or more test results.

13. The system of claim 8, wherein the vulnerability is identified by a vulnerability scanner, and wherein, responsive to executing the instructions, further causes the system to:
determining, buy the vulnerability scanner, one or more properties of the initial source code; and
identifying, based on the one or more properties, the vulnerability from a plurality of vulnerabilities included in a global vulnerability database.

14. The system of claim 8, wherein, responsive to executing the instructions, further causes the system to:
evaluating the initial source code by the AIM prior to generating the prompt;
identifying, by the AIM in response to evaluating the initial source code, a plurality of potential vulnerabilities that correspond to the initial source code;
generating a new prompt comprising the initial source code and the plurality of potential vulnerabilities;
in response to inputting the new prompt into the AIM, determining, by the AIM, that the initial source code comprises a first vulnerability from the plurality of potential vulnerabilities; and
removing, by the AIM, the first vulnerability from the initial source code to produce a new refactored source code.

15. A non-transitory computer readable medium, having instructions stored thereon which, when executed by a processing device, cause the processing device to:
identify a vulnerability corresponding to an initial source code;
generate a prompt comprising the initial source code and the vulnerability;
input the prompt into an artificial intelligence model (AIM) that is trained to determine whether the initial source code comprises the vulnerability; and
remove, by the processing device using the AIM, the vulnerability from the initial source code to produce a refactored source code in response to a determination that the initial source code comprises the vulnerability.

16. The non-transitory computer readable medium of claim 15, wherein the processing device is to:
detect a zero-day vulnerability corresponding to the initial source code, wherein the AIM has not been trained on the zero-day vulnerability;
determine one or more zero-day refactoring operations corresponding to the zero-day vulnerability;
generate a new prompt comprising the initial source code, the zero-day vulnerability, and the one or more zero-day refactoring operations;
in response to inputting the new prompt into the AIM, determine, by the AIM, that the initial source code comprises the zero-day vulnerability; and
removing, by the AIM, the zero-day vulnerability from the initial source code to produce a new refactored source code.

17. The non-transitory computer readable medium of claim 15, wherein the AIM is a security code analysis copilot AIM, and wherein the processing device is to:
generating a training prompt that comprises training source code, one or more vulnerabilities contexts corresponding to the training source code, and one or more code refactoring techniques descriptions;
inputting the training prompt and a ground truth into a pretrained AIM, wherein the pretrained AIM performs fine tune training based on the training prompt and the ground truth to produce the security code analysis copilot AIM.

18. The non-transitory computer readable medium of claim 17, wherein the processing device is to:
detecting one or more new vulnerabilities;
in response to determining that the one or more new vulnerabilities comprise one or more distinguishing contexts relative to the one or more vulnerabilities contexts, retraining the security code analysis copilot AIM, wherein the retraining comprises:
generating a new training prompt that comprises new training source code, the one or more new vulnerabilities, and the one or more distinguishing contexts; and
inputting the new training prompt into the security code analysis copilot AIM, wherein the security code analysis copilot AIM performs new fine tune training based on the new prompt to produce a retrained security code analysis copilot AIM.

19. The non-transitory computer readable medium of claim 15, wherein the AIM produces a plurality of refactored candidate samples, and wherein the processing device is to:
testing at least a portion of code included in each of the plurality of refactored candidate samples to produce one or more test results; and
constructing the refactored source code based on the one or more test results.

20. The non-transitory computer readable medium of claim 15, wherein the processing device is to:
evaluating the initial source code by the AIM prior to generating the prompt;
identifying, by the AIM in response to evaluating the initial source code, a plurality of potential vulnerabilities that correspond to the initial source code;
generating a new prompt comprising the initial source code and the plurality of potential vulnerabilities;
in response to inputting the new prompt into the AIM, determining, by the AIM, that the initial source code comprises a first vulnerability from the plurality of potential vulnerabilities; and
removing, by the AIM, the first vulnerability from the initial source code to produce a new refactored source code.
